(19) United States
(12) Patent Application Publication
(10) Pub. No.: US 2012/0176969 A1
(43) Pub. Date: Jul. 12, 2012

(54) SYNCHRONIZATION OF AN ACCESS POINT IN A COMMUNICATION NETWORK

(76) Inventor: Juergen Michel, Munich (DE)

(21) Appl. No.: 13/391,081

(22) PCT Filed: Aug. 17, 2010
(86) PCT No.: PCT/EP10/61953

§ 371 Date: Mar. 20, 2012

(30) Foreign Application Priority Data
Aug. 17, 2009 (EP) 09167994.4

(51) Int. Cl. H04W 56/00

(52) U.S. Cl. 370/328

(57) ABSTRACT

The present invention relates to apparatuses, method and computer program product for setting the timing of control signal transmission in a communication network access point. The present invention discloses obtaining information on external control signal timing, randomly offsetting internal control signal timing with respect to the external control signal timing, and providing information on the randomly offset internal control signal timing.

### FIELD OF THE INVENTION

The present invention relates to an apparatus, method, system and computer program product for setting the timing of control signal transmission in a communication network access point.

### RELATED BACKGROUND ART

Prior art which is related to this technical field can e.g. be found by the technical specification TS 36.300 (current version: 9.0.0) of the 3GPP, by the contribution documents R1-083366 and R1-092350 of the working group 1 of the 3GPP related to radio access networks, and by the contribution document R3-091018 of the working group 3 of the 3GPP related to radio access networks.

The following meanings for the abbreviations used in this specification apply:

3GPP: 3^{rd} Generation Partnership Project

DL: Downlink

eNB: Evolved NodeB

FDD: Frequency Division Duplex

GPS: Global Positioning System

HeNB: Home evolved NodeB

ID: Identity

LTE: Long Term Evolution

LTE-A: LTE-Advanced

OAM: Operations and Maintenance

PCI: Physical Cell ID

PSS: Primary Synchronization Signal

RAN: Radio Access Network

SSS: Secondary Synchronization Signal

UE: User Equipment

WA: Wide Area

WLAN: Wireless Local Area Network

WIMAX: Worldwide Interoperability for Microwave Access

Recently, for mobile wireless communication systems such as those according to 3GPP LTE low transmission power eNBs (which in the following are called Home eNodeBs) are proposed. These nodes can be operated at the same frequency layer, i.e. the same carrier frequency in the same frequency band, as a wide area eNB. A similar situation is provided by general small nodes with local services applied, and which are under an overlay wide area macro network operated on the same frequency layer.

It is typical for nodes such as these HeNBs that they are low cost and in general deployed in indoor environment. In terms of radio network planning, the deployment is in most cases uncoordinated, i.e. the exact positions of the nodes and the fact whether the nodes are switched on or off is not fully known to the network operator at any time.

Accordingly, the HeNBs need to be auto-configured (i.e. self-configured by automatic procedure). Since the HeNBs may generally support any nearby UE, the UE need to be enabled to distinguish the HeNBs. This can be done by using a PCI (a DL scrambling code).

According to the technical specification TS 36.300, an eNB shall base the selection of its PCI either on a centralized or distributed PCI assignment algorithm. That is, according to a centralized PCI assignment, the OAM signals a specific PCI value. The eNB shall select this value as its PCI. Whereas, according to a distributed PCI assignment, the OAM signals a list of PCI values. The eNB may restrict this list by removing PCIS that are reported by UEs, reported over the X2 interface (i.e. the interface connecting neighboring eNBs) by neighboring eNBs; and/or acquired through other implementation dependent methods, e.g. heard over the air using a downlink receiver. Then, the eNB shall select a PCI value randomly from the remaining list of PCIS.

Accordingly, in a thus organized wide area network a centralized PCI selection algorithm relies on the OAM to provide a single PCI value that is not in collision with any of its neighbors. For a network planned macro deployment, this is possible to achieve, based on careful design (centralized planning of PCIs).

However, in an uncoordinated, heterogeneous network deployment with HeNBs or pico cells, this is impossible to achieve and the reasoning for this is:
HeNBs are deployed in an ad-hoc manner;
the exact location of HeNBs is impossible to determine in many cases;
even if the HeNBs report detailed radio measurements to OAM, such radio measurements can change very quickly; and
the HeNB itself may be moved.

Therefore, the PCI assignment can never eliminate collisions in uncoordinated, heterogeneous network, and the distributed, decentralized or random algorithms are needed.

Though, recent simulations as e.g. reported in documents R1-083366 and R1-092350 as identified above showed that PCI collision probability among neighboring HeNBs is in general small. Further, from physical layer perspective the UE to HeNB connection does not really suffer much from this and therefore it is expected that collision probabilities as low as analyzed in uncoordinated, heterogeneous deployments will be tolerated by the 3GPP standard.

### SUMMARY OF THE INVENTION

It is thus an object of the present invention to further improve avoidance of code collision.

According to a first aspect of the present invention, this is accomplished by an apparatus, comprising means configured to obtain information on external control signal timing; means configured to randomly offset internal control signal timing with respect to the external control signal timing; and means configured to provide information on the randomly offset internal control signal timing.

Modifications of the first aspect may be as follows.

The apparatus according to the first aspect may be configured to be suitable for setting the timing of control signal transmission in a communication network access point.

The apparatus may further comprise means configured to change the randomly offset internal control signal timing in response to obtained change information.

The change information may be an indication of accordance in both a communication cell identifier and a random offset corresponding to the randomly offset internal control signal timing.

Alternatively, the change information may be one of a non-acknowledgment, a not received acknowledgement after expiration of a set time, and an explicit error message.

The means configured to change the randomly offset internal control signal timing may be further configured to trigger a new generation of the randomly offset internal control signal timing, or to adopt new randomly offset internal control signal timing according to an obtained random offset. Further, the means configured to trigger a new generation of the randomly offset internal control signal timing may be further configured to trigger the new generation of the randomly offset internal control signal timing until a random offset is different from a preceding one.

The external control signal timing may be the control signal timing of a wide area communication cell. Each of the external control signal timing and the internal control signal timing may comprise ten sub-frames. The means configured to randomly offset internal control signal timing with respect to the external control signal timing may be further configured to synchronize a randomly selected one of the first to tenth sub-frame of the internal control signal timing with the first sub-frame of the external control signal timing. Alternatively, the means configured to randomly offset internal control signal timing with respect to the external control signal timing are further configured to synchronize a randomly selected one of the second to tenth sub-frame of the internal control signal timing with the first sub-frame of the external control signal timing.

The external control signal timing may be a virtual control signal timing of a global positioning system. The virtual control signal timing of the global positioning system may be obtained by transforming a linear timing of the global positioning system into periodic frame or sub-frame based timing.

For the LTE and LTE-A frame structure this may be effected by modulo/div operation according to {(GPS time [ms]) mod (10 ms)} div 1+1, where GPS time is the linear timing of the global positioning system. The result is a periodic timing with 10 ms period consisting of 10 sub-frames 1,2, . . . ,10 per period. Each of the thus obtained external control signal timing and the internal control signal timing may comprise ten sub-frames. The means configured to randomly offset internal control signal timing with respect to the external control signal timing may be further configured to synchronize a randomly selected one of the first to tenth sub-frame of the internal control signal timing with the first sub-frame of the external control signal timing. Alternatively, the means configured to randomly offset internal control signal timing with respect to the external control signal timing are further configured to synchronize a randomly selected one of the second to tenth sub-frame of the internal control signal timing with the first sub-frame of the external control signal timing.

The apparatus may further comprise means configured to receive a signal comprising the linear timing of a global positioning system.

The apparatus may further comprise means configured to obtain the linear timing of a global positioning system from a wireless communication terminal which is in wireless connection with said means.

According to a second aspect of the present invention, the object is accomplished by an apparatus, comprising an external connection processor configured to obtain information on external control signal timing; a random offset processor configured to randomly offset internal control signal timing with respect to the external control signal timing; and an information provision processor configured to provide information on the randomly offset internal control signal timing.

Modifications of the second aspect may correspond to the modifications of the first aspect.

According to a third aspect of the present invention, the object is accomplished by an evolved Node B, comprising the apparatus according to the first or second aspect or any of their modifications.

Furthermore, the evolved Node B according to the third aspect may be implemented as a home evolved Node B.

According to a fourth aspect of the present invention, the object is accomplished by an apparatus, comprising means configured to command to an evolved Node B functionality to obtain external control signal timing from a particular wide area communication cell in which the evolved Node B functionality is located, for randomly offsetting the internal control signal timing of the evolved Node B functionality with respect to the external control signal timing.

Modifications of the fourth aspect may be as follows.

The apparatus according to the fourth aspect may be configured to be suitable for setting the timing of control signal transmission in a communication network access point.

The apparatus may further comprise means configured to provide a functionality of a central network entity such as an operation and maintenance functionality by an application specific hardware implementation or by a software implementation using a general purpose processor such as a digital signal processor.

The apparatus may further comprise means configured to acknowledge to the evolved Node B functionality a specific offset of its internal control signal timing with respect to the control signal timing of the particular wide area communication cell. Said means may alternatively or additionally configured to reject to the evolved Node B functionality the specific offset and/or to provide an explicit error message to the evolved Node B functionality.

The apparatus may further comprise means configured to compare the specific offset of the evolved Node B functionality with another specific offset of the internal control signal timing of another evolved Node B functionality and to further compare a communication cell identifier used by the evolved Node B functionality with a communication cell identifier used by the another evolved Node B functionality, and to command a change of the specific offset to the evolved Node B functionality if both the evolved Node B functionality and the another evolved Node B functionality use the same specific offset and communication cell identifier.

The apparatus may further comprise means configured to provide the evolved Node B functionality with a specific offset of its internal control signal timing with respect to a control signal timing of a particular wide area communication cell in which the evolved Node B functionality is located.

According to a fifth aspect of the present invention, the object is accomplished by an apparatus, comprising a timing control processor configured to command to an evolved Node B functionality to obtain external control signal timing from a particular wide area communication cell in which the evolved Node B functionality is located, for randomly offsetting the internal control signal timing of the evolved Node B functionality with respect to the external control signal timing.

Modifications of the fifth aspect may correspond to the modifications of the fourth aspect.

According to a sixth aspect of the present invention, the object is accomplished by a system comprising an apparatus according to the first aspect or any of its modifications as well as an apparatus according to the fourth aspect or any of its modifications or comprising an apparatus according to the second aspect or any of its modifications as well as an apparatus according to the fifth aspect or any of its modifications.

Alternatively, the apparatus according to the first and the second aspect, respectively, may be replaced by the evolved Node B according to the third aspect.

According to a seventh aspect of the present invention, the object is accomplished by a method, comprising obtaining information on external control signal timing; randomly offsetting internal control signal timing with respect to the external control signal timing; and providing information on the randomly offset internal control signal timing.

Modifications of the seventh aspect may be as follows.

The method according to the seventh aspect may be suitable for setting the timing of control signal transmission in a communication network access point.

The method may further comprise changing the randomly offset internal control signal timing in response to obtained change information.

The change information may be an indication of accordance in both a communication cell identifier and a random offset corresponding to the randomly offset internal control signal timing.

Alternatively, the change information may be one of a non-acknowledgment, a not received acknowledgement after expiration of a set time, and an explicit error message.

Changing the randomly offset internal control signal timing may further include triggering a new generation of the randomly offset internal control signal timing, or adopting new randomly offset internal control signal timing according to an obtained random offset. Further, triggering a new generation of the randomly offset internal control signal timing may further include triggering the new generation of the randomly offset internal control signal timing until a random offset is different from a preceding one.

The external control signal timing may be the control signal timing of a wide area communication cell. Each of the external control signal timing and the internal control signal timing may comprise ten sub-frames. Randomly offsetting internal control signal timing with respect to the external control signal timing may further include synchronizing a randomly selected one of the first to tenth sub-frame of the internal control signal timing with the first sub-frame of the external control signal timing. Alternatively, randomly offsetting internal control signal timing with respect to the external control signal timing may further include synchronizing a randomly selected one of the second to tenth sub-frame of the internal control signal timing with the first sub-frame of the external control signal timing.

The external control signal timing may be a virtual control signal timing of a global positioning system. The virtual control signal timing of the global positioning system may be obtained by transforming a linear timing of the global positioning system into periodic frame or sub-frame based timing. For the LTE and LTE-A frame structure this may be effected by modulo/div operation according to {(GPS time [ms]) mod (10 ms)} div 1+1, where GPS time is the linear timing of the global positioning system. The result is a periodic timing with 10 ms period consisting of 10 sub-frames 1,2, . . . ,10 per period. Each of the thus obtained external control signal timing and the internal control signal timing may comprise ten sub-frames. Randomly offsetting internal control signal timing with respect to the external control signal timing may further include synchronizing a randomly selected one of the first to tenth sub-frame of the internal control signal timing with the first sub-frame of the external control signal timing. Alternatively, randomly offsetting internal control signal timing with respect to the external control signal timing may further include synchronizing a randomly selected one of the second to tenth sub-frame of the internal control signal timing with the first sub-frame of the external control signal timing.

The method may further comprise receiving a signal comprising the linear timing of a global positioning system.

The method may further comprise obtaining the linear timing of a global positioning system from a wireless communication terminal over a wireless connection.

According to an eighth aspect of the present invention, the object is accomplished by a method, comprising commanding to an evolved Node B functionality to obtain external control signal timing from a particular wide area communication cell in which the evolved Node B functionality is located, for randomly offsetting the internal control signal timing of the evolved Node B functionality with respect to the external control signal timing.

Modifications of the eighth aspect may be as follows.

The method according to the eighth aspect may suitable for setting the timing of control signal transmission in a communication network access point.

The method may further comprise providing a functionality of a central network entity such as an operation and maintenance functionality by an application specific hardware implementation or by a software implementation using a general purpose processor such as a digital signal processor.

The method further comprise acknowledging to the evolved Node B functionality a specific offset of its internal control signal timing with respect to the control signal timing of the particular wide area communication cell. The method may alternatively or additionally comprise rejecting to the evolved Node B functionality the specific offset and/or providing an explicit error message to the evolved Node B functionality.

The method may further comprise comparing the specific offset of the evolved Node B functionality with another specific offset of the internal control signal timing of another evolved Node B functionality and further comparing a communication cell identifier used by the evolved Node B functionality with a communication cell identifier used by the another evolved Node B functionality, and commanding a change of the specific offset to the evolved Node B functionality if both the evolved Node B functionality and the another evolved Node B functionality use the same specific offset and communication cell identifier.

The method may further comprise providing the evolved Node B functionality with a specific offset of its internal control signal timing with respect to a control signal timing of a particular wide area communication cell in which the evolved Node B functionality is located.

According to a ninth aspect of the present invention, the above object is accomplished by a computer program product comprising computer-executable components which perform, when the program is run on a computer, obtaining information on external control signal timing; randomly offsetting internal control signal timing with respect to the external control signal timing; and providing information on the randomly offset internal control signal timing.

Modifications of the ninth aspect may be as follows.

The computer program product according to the ninth aspect may be configured to be suitable for setting the timing of control signal transmission in a communication network access point.

The computer program product according to the ninth aspect may be embodied as a computer-readable storage medium.

Otherwise, modifications of the ninth aspect may correspond to the modifications of the seventh aspect.

According to a tenth of the present invention, the above object is accomplished by a computer program product comprising computer-executable components which perform, when the program is run on a computer, commanding to an evolved Node B functionality to obtain external control signal timing from a particular wide area communication cell in which the evolved Node B functionality is located, for randomly offsetting the internal control signal timing of the evolved Node B functionality with respect to the external control signal timing.

Modifications of the tenth aspect may be as follows.

The computer program product according to the tenth aspect may be configured to be suitable for setting the timing of control signal transmission in a communication network access point.

The computer program product according to the tenth aspect may be embodied as a computer-readable storage medium.

Otherwise, modifications of the tenth aspect may correspond to the modifications of the eighth aspect.

It is to be understood that any of the above modifications can be applied singly or in combination to the respective aspects to which they refer, unless they are explicitly stated as excluding alternatives.

### BRIEF DESCRIPTION OF THE DRAWINGS

These and other objects, features, details and advantages will become more fully apparent from the following detailed description of the preferred embodiments which is to be taken in conjunction with the appended drawings, in which:

FIG. 1a shows a first apparatus according to certain embodiments of the present invention;

FIG. 1b shows a second apparatus according to certain embodiments of the present invention and some modifications thereof;

FIG. 2 shows a method according to certain embodiments of the present invention;

FIG. 3 shows another method according to certain embodiments of the present invention and some modifications thereof; and

FIG. 4 shows a handover scenario from a WA eNB to a HeNB according to certain embodiments of the present invention.

### DETAILED DESCRIPTION OF THE PREFERRED EMBODIMENTS

In the following, description will be made to what are presently considered to be preferred embodiments of the present invention. It is to be understood, however, that the description is given by way of example only, and that the described embodiments are by no means to be understood as limiting the present invention thereto.

For example, for illustration purposes, in some of the following exemplary embodiments, a setting of the timing of control signal transmission in an access point of a 3GPP LTE network is described. However, it should be appreciated that these exemplary embodiments are not limited for use among this particular type of wireless communication system, and according to further exemplary embodiments, the present invention can be applied also to a setting of the timing of control signal transmission in an access point in other types of fixed or wireless communication systems and access networks such as e.g. to WLAN (wireless local area network) and WIMAX (worldwide interoperability for microwave access) techniques and standards.

Thus, according to certain embodiments of the present invention, an apparatus, method, system and computer program product for setting of the timing of control signal transmission in a communication network access point is described. Implementation examples of certain embodiments of the present invention are related to HeNB equipment and central network entity equipment such as OAM equipment, but are not limited thereto.

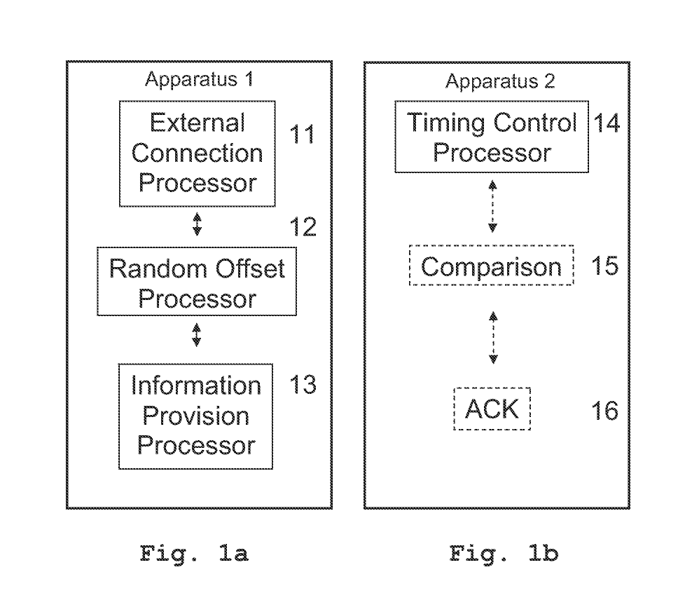

For example, FIG. 1a shows a first apparatus 1 according to certain embodiments of the present invention. The apparatus 1 comprises an external connection processor 11 configured to obtain information on external control signal timing. Further, the apparatus 1 comprises a random offset processor 12 configured to randomly offset internal control signal timing with respect to the external control signal timing, and an information provision processor 13 configured to provide information on the randomly offset internal control signal timing.

On the other hand, FIG. 1b shows a second apparatus 2 according to certain embodiments of the present invention and some modifications thereof. The apparatus 2 comprises a timing control processor 14 configured to command to an evolved Node B functionality to obtain external control signal timing from a particular wide area communication cell in which the evolved Node B functionality is located, for randomly offsetting the internal control signal timing of the evolved Node B functionality with respect to the external control signal timing. In a modification according to certain embodiments of the present invention, the apparatus 2 may further comprise a comparison processor 15 configured to compare the specific offset of the evolved Node B functionality with another specific offset of the internal control signal timing of another evolved Node B functionality and to further compare a communication cell identifier used by the evolved Node B functionality with a communication cell identifier used by the another evolved Node B functionality, and to command a change of the specific offset to the evolved Node B functionality if both the evolved Node B functionality and the another evolved Node B functionality use the same specific offset and communication cell identifier. In addition, according to still further certain embodiments, the apparatus 2 may alternatively or additionally comprise an acknowledgement processor 16 configured to acknowledge to the evolved Node B functionality a specific offset of its internal control signal timing with respect to the control signal timing of the particular wide area communication cell.

From the above description, it will be understood that according to still further certain embodiments of the present invention the apparatus 1 and the apparatus 2 in combination may form a system, wherein the apparatus 1 may serve as an evolved Node B functionality to the apparatus 2.

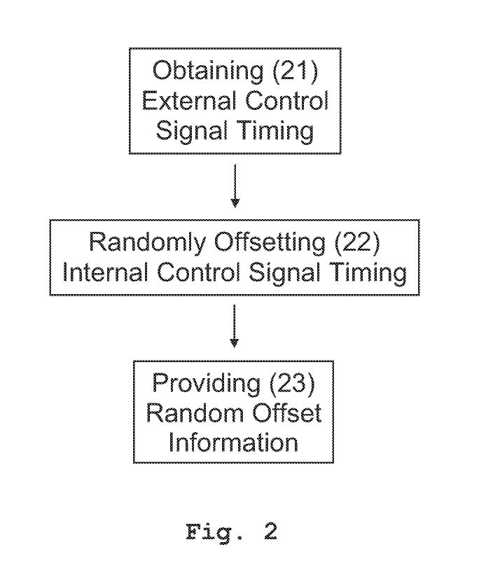

FIG. 2 shows a method according to certain embodiments of the present invention. The method comprises obtaining 21 information on external control signal timing, randomly offsetting 22 internal control signal timing with respect to the external control signal timing, and providing 23 information on the randomly offset internal control signal timing.

The method shown in FIG. 2 may be executed by the apparatus 1 shown in FIG. 1a, and the respective processes may be performed by the respective elements of the apparatus 1 according to the according descriptions.

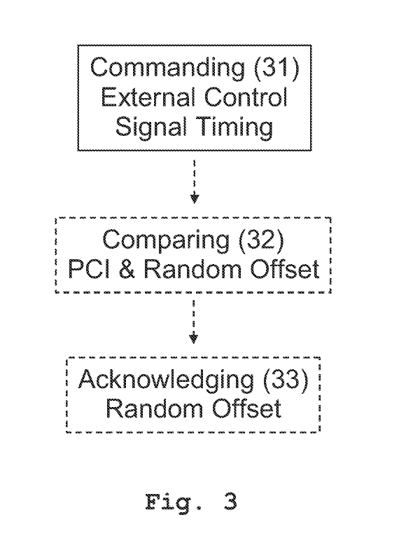

FIG. 3 shows another method according to certain embodiments of the present invention and some modifications thereof. The another method comprises commanding 31 to an evolved Node B functionality to obtain external control signal timing from a particular wide area communication cell in which the evolved Node B functionality is located, for randomly offsetting the internal control signal timing of the evolved Node B functionality with respect to the external control signal timing.

The another method may further comprise comparing 32 the specific offset of the evolved Node B functionality with another specific offset of the internal control signal timing of another evolved Node B functionality and further comparing 32 a communication cell identifier (e.g. PCI) used by the evolved

Node B functionality with a communication cell identifier (e.g. PCI) used by the another evolved Node B functionality, and commanding a change of the specific offset to the evolved Node B functionality if both the evolved Node B functionality and the another evolved Node B functionality use the same specific offset and communication cell identifier.

The another method may still further or alternatively comprise acknowledging 33 to the evolved Node B functionality a specific offset of its internal control signal timing with respect to the control signal timing of the particular wide area communication cell.

The method shown in FIG. 3 may be executed by the apparatus 2 shown in FIG. 1b, and the respective processes may be performed by the respective elements of the apparatus 2 according to the according descriptions.

Furthermore, executing both the method according to FIG. 2 and the method according to FIG. 3 leads to a system related method according to still further certain embodiments of the present invention.

Further details and modifications of the above described certain embodiments of the present invention as well as implementation examples thereof may become apparent from the following further description.

Specifically, according to certain embodiments of the present invention, it is considered that for higher layer procedures like handover and measurement reporting, cells with a same PCI, i.e. code collision, can be distinguished by having a different timing of downlink control channels (e.g. PSS/SSS) so as to enable a unique identification of candidate handover cells.

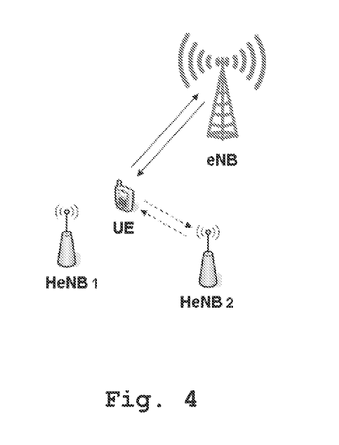

FIG. 4 shows a possible handover example for the case of inbound handover of a UE from WA macro cell to HeNB. Specifically, if it is assumed a HeNB code collision, i.e. that HeNB1 and HeNB2 would have the same PCI (e.g. PCI=13), they can be distinguished in handover measurements reported to the serving eNB either by forcing the UE to read the full broadcast channel of HeNBs where the global (long and unique) HeNB ID is transmitted or by utilizing the time offset information (timing difference of measured HeNB PSS/SSS to connected (serving) macro cell PSS/SSS) and the PCI.

Though, there can be a problem that the timing of the HeNB is not specified so far, and e.g. in a case after a power outage, if a certain amount of neighboring HeNBs are reactivated at the same time, it may happen that the timing of these is similar or the same (due to the same start-up time of HeNB) to each other. Therefore, if PCI collision appears, a timing differentiation may not be possible or be at least quite limited due to the case that all the neighboring HeNBs may have the same time understanding.

However, according to certain embodiments of the present invention, FDD HeNBs are expected to be deployed in an unsynchronized way (in the time domain). Therefore, the timing of HeNB1 to the macro cell and of HeNB2 to the macro cell is in general selectable or adjustable without further impact on the network operation/performance.

Hence, according to certain embodiments of the present invention, the problem which may occur in uncoordinated heterogeneous networks that in case of PCI collisions, there is a need to utilize a timing differentiator during handover procedures/measurements to uniquely identify HeNBs, may be solved as follows.

Specifically, to ensure that even if HeNBs are re-powered at the same time (e.g. after power outage) HeNBs can be differentiated by timing even if there is PCI collision, according to certain embodiments of the present invention, the HeNB can set its timing as follows:

The HeNB monitors the wide area overlay cells for a sub-frame No. 0 (out of 10 sub-frames of the signaling in the DL control channel) and starts its own DL control signaling with a random sub-frame out of sub-frames 0 to 9 (i.e. sub-frame No. rnd[0,9]) in parallel to the sub-frame No. 0 of the wide area overlay cell such as e.g. according to LTE/LTE-A.

Alternatively, the HeNB monitors the wide area overlay cells for a sub-frame No. 0 (out of 10 sub-frames of the signaling in the DL control channel) and starts its own DL control signaling with a random sub-frame out of sub-frames 1 to 9 (i.e. sub-frame No. rnd[1,9]) in parallel to the sub-frame No. 0 of the wide area overlay cell such as e.g. according to LTE/LTE-A.

Excluding a synchronization of the first sub-frame of internal control signal timing with the first sub-frame of external control signal timing in LTE and LTE-A may be beneficial, since it can be thus avoided that HeNBs or low power nodes and high power nodes which form the overlay network do not interfere due to transmission of the same control channels or signals (like primary synchronization signal, secondary synchronization signal and broadcast control channel) at the same time.

According to certain embodiments of the present invention, the network can determine which of the wide area cells a HeNB can monitor is used for reference timing.

According to further certain embodiments of the present invention, the HeNB is signaling the random value obtained as described above to a central network element such as an OAM configuration managing entity, where the value is acknowledged to the HeNB or changed. In the latter case, this may be due to the fact that the PCI is the same with another HeNB and still both HeNBs are receiving the same or similar set of wide area overlay neighbors and furthermore have the same random values.

As another option according to further certain embodiments of the present invention, if the random value is not acknowledged, either simply a new random value is generated by the HeNB or a timing value and the reference wide area overlay cell is explicitly signaled to the HeNB.

As another alternative according to further certain embodiments of the present invention, the HeNB applies and utilizes the calculated random value without waiting for acknowledgement until an internal timer is exceeded and in case, either simply a new random value is generated by the HeNB or a timing value and the reference wide area overlay cell is explicitly signaled to the HeNB.

As a further alternative and according to other certain embodiments of the present invention, the HeNB includes a GPS and conducts one or more of the processes described in the above procedure and its options, except that instead of utilizing the timing of the overlay wide area LTE/LTE-A cell, the GPS timing is used, and the linear GPS timing is transformed into a periodic LTE sub-frame-like timing by utilizing the following formula:

{(GPS time [ms]) mod (10 ms)} div 1+1

As a further alternative and according to still further certain embodiments, the HeNB may not include a GPS, and for example in case that the HeNB cannot monitor a wide area LTE/LTE-A overlay cell, the HeNB can monitor the timing from UE comprising a GPS which is/are in the range of the HeNB. One or more of the processes of the above described procedure can be conducted in an analogous manner.

Further, according to certain embodiments of the present invention, implementation examples are related to LTE HeNB and central network entities such as OAM equipment, but are not limited thereto.

According to the above description, it should thus be apparent that exemplary embodiments of the present invention provide, for example from the perspective of a network element such as a Home evolved Node B (HeNB), and/or a central network element such as a OAM entity, or a component thereof, an apparatus embodying the same, a method for controlling and/or operating the same, and computer program(s) controlling and/or operating the same as well as mediums carrying such computer program(s) and forming computer program product(s).

For example, described above are apparatuses, methods and computer program products capable of setting the timing of control signal transmission in a communication network access point.

Implementations of any of the above described blocks, apparatuses, systems, techniques or methods include, as non limiting examples, implementations as hardware, software, for example in connection with a digital signal processor, firmware, special purpose circuits or logic, general purpose hardware or controller or other computing devices, or some combination thereof.

What is described above is what is presently considered to be preferred embodiments of the present invention. However, as is apparent to the skilled reader, these are provided for illustrative purposes only and are in no way intended that the present invention is restricted thereto. Rather, it is the intention that all variations and modifications be included which fall within the spirit and scope of the appended claims.

1. A method, comprising:
obtaining information on external control signal timing;
randomly offsetting internal control signal timing with respect to the external control signal timing; and
providing information on the randomly offset internal control signal timing.

2. The method according to claim 1, further comprising setting the timing of control signal transmission in a communication network access point.

3. The method according to claim 1, further comprising changing the randomly offset internal control signal timing in response to obtained change information.

4. The method according to claim 3, wherein
the change information is an indication of accordance in both a communication cell identifier and a random offset corresponding to the randomly offset internal control signal timing.

5. The method according to claim 3, wherein
the change information is one of a non-acknowledgment, a not received acknowledgement after expiration of a set time, and an explicit error message.

6. The method according to claim 3, wherein
changing the randomly offset internal control signal timing further includes triggering a new generation of the randomly offset internal control signal timing, or adopting new randomly offset internal control signal timing according to an obtained random offset.

7. The method according to claim 6, wherein
triggering a new generation of the randomly offset internal control signal timing further includes triggering the new generation of the randomly offset internal control signal timing until a random offset is different from a preceding one.

8. The method according to claim 1, wherein
the external control signal timing is the control signal timing of a wide area communication cell.

9. The method according to claim 1, wherein the external control signal timing is the timing of a strongest received wide area communication cell.

10. The method according to claim 1, wherein
each of the external control signal timing and the internal control signal timing comprises ten sub-frames.

11. The method according to claim 10, wherein
randomly offsetting internal control signal timing with respect to the external control signal timing further includes synchronizing a randomly selected one of the first to tenth sub-frame of the internal control signal timing with the first sub-frame of the external control signal timing.

12. The method according to claim 10, wherein
randomly offsetting internal control signal timing with respect to the external control signal timing further includes synchronizing a randomly selected one of the second to tenth sub-frame of the internal control signal timing with the first sub-frame of the external control signal timing.

13. The method according to claim 1, wherein
the external control signal timing is a virtual control signal timing of a global positioning system.

14. The method according to claim 13, wherein
the virtual control signal timing of the global positioning system is obtained by transforming a linear timing of the global positioning system into periodic frame or sub-frame based timing.

15. The method according to claim 14, further comprising
receiving a signal comprising the linear timing of a global positioning system.

16. The method according to claim 14, further comprising
obtaining the linear timing of a global positioning system from a wireless communication terminal over a wireless connection.

17. An apparatus, comprising:
means configured to obtain information on external control signal timing;
means configured to randomly offset internal control signal timing with respect to the external control signal timing; and
means configured to provide information on the randomly offset internal control signal timing.

18. The apparatus according to claim 17, wherein
the apparatus is configured to be suitable for setting the timing of control signal transmission in a communication network access point.

19. The apparatus according to claim 17, further comprising means configured to change the randomly offset internal control signal timing in response to obtained change information.

20. The apparatus according to claim 19, wherein the change information is an indication of accordance in both a communication cell identifier and a random offset corresponding to the randomly offset internal control signal timing.

21. The apparatus according to claim 19, wherein
the change information is one of a non-acknowledgment, a not received acknowledgement after expiration of a set time, and an explicit error message.

22. The apparatus according to claim 19, wherein
the means configured to change the randomly offset internal control signal timing is further configured to trigger a new generation of the randomly offset internal control signal timing, or to adopt new randomly offset internal control signal timing according to an obtained random offset.

23. The apparatus according to claim 22, wherein
the means configured to trigger a new generation of the randomly offset internal control signal timing is further configured to trigger the new generation of the randomly offset internal control signal timing until a random offset is different from a preceding one.

24. The apparatus according to claim 17, wherein
the external control signal timing is the control signal timing of a wide area communication cell.

25. The apparatus according to claim 17, wherein
the external control signal timing is the timing of a strongest received wide area communication cell.

26. The apparatus according to claim 17, wherein
each of the external control signal timing and the internal control signal timing may comprise ten sub-frames.

27. The apparatus according to claim 26, wherein
the means configured to randomly offset internal control signal timing with respect to the external control signal timing is further configured to synchronize a randomly selected one of the first to tenth sub-frame of the internal control signal timing with the first sub-frame of the external control signal timing.

28. The apparatus according to claim 26, wherein
the means configured to randomly offset internal control signal timing with respect to the external control signal timing is further configured to synchronize a randomly selected one of the second to tenth sub-frame of the internal control signal timing with the first sub-frame of the external control signal timing.

29. The apparatus according to claim 17, wherein
the external control signal timing is a virtual control signal timing of a global positioning system.

30. The apparatus according to claim 29, wherein
the virtual control signal timing of the global positioning system is obtained by transforming a linear timing of the global positioning system into periodic frame or sub-frame based timing.

31. The apparatus according to claim 30, further comprising means configured to receive a signal comprising the linear timing of a global positioning system.

32. The apparatus according to claim 30, further comprising
means configured to obtain the linear timing of a global positioning system from a wireless communication terminal which is in wireless connection with said means.

33. An apparatus comprising:
an external connection processor configured to obtain information on external control signal timing;
a random offset processor configured to randomly offset internal control signal timing with respect to the external control signal timing; and
an information provision processor configured to provide information on the randomly offset internal control signal timing.

34. A computer program product including a program for a processing device, comprising software code portions for performing the steps of claim 1 when the program is run on the processing device.

35. The computer program product according to claim 34, wherein the computer program product comprises a computer-readable medium on which the software code portions are stored.

36. The computer program product according to claim 34, wherein the program is directly loadable into an internal memory of the processing device.
